(19) United States
(12) Patent Application Publication
(10) Pub. No.: US 2013/0021820 A1
(43) Pub. Date: Jan. 24, 2013

(54) BACKLIGHT DEVICE AND DISPLAY DEVICE

(71) Applicant: Satoshi Ueda, Osaka-shi (JP)

(72) Inventor: Satoshi Ueda, Osaka-shi (JP)

(21) Appl. No.: 13/639,549

(22) PCT Filed: Feb. 15, 2011
(86) PCT No.: PCT/JP2011/053083

§ 371 Date: Oct. 5, 2012

(30) Foreign Application Priority Data
Apr. 21, 2010 (JP) 2010-097709

(51) Int. Cl. G09F 13/18; F21V 13/02; F21V 8/00

(52) U.S. Cl. 362/608; 362/613

(57) ABSTRACT

Provided is a backlight device which can reduce the size and weight of light-guiding members while also improving light use efficiency. The backlight device (10) is provided with a light-guiding plate (11) and a plurality of LEDs (12) which irradiate the light-guiding plate with light. The light-guiding plate includes a plurality of side surfaces (11a) and a plurality of light incident surfaces (11b) which are formed in a plurality of corners and are arranged opposite the LEDs. The side surfaces are arranged between adjacent light incident surfaces and are formed in convex shapes.

### TECHNICAL FIELD

The present invention relates to a backlight device and a display device, and in particular, the present invention relates to a backlight device and a display device that have a point light source disposed at a corner of a light guide member.

### BACKGROUND ART

Conventionally, there has been known a backlight device including a point light source such as an LED (Light Emitting Diode) and a light guide member which light from the point light source enters. In a case of using point light sources in a backlight device, it is possible to reduce the number of point light sources by arranging the point light sources at corners of the light guide member.

FIG. 21 is a top view showing a configuration of a backlight device according to a conventional example where LEDs (point light sources) are disposed at the corners of a light guide plate (a light guide member). As shown in FIG. 21, a backlight device 501 according a conventional example includes a rectangular light guide plate (a light guide member) 510 and LEDs (point light sources) 520 which are disposed at the four corners (four corner portions) of the light guide plate 510 to face the four corners.

In the backlight device 501 according to the conventional example shown in FIG. 21, a substantial entirety of the light guide plate 510 is an effective light emitting region corresponding to a display region of a display panel (not shown). Besides, in the backlight device 501, in each of the four corners of the light guide plate 510, a portion that is located to face an LED 520 is formed inclined with respect to a light emitting surface 520a of the LED 520. That is, in each of the four corners of the light guide plate 510, the surface on which light is incident is not formed perpendicular to the optical axis 501 of the LED 520. As a result, light emitted from the LED 520 is prone to be reflected on a surface of the light guide plate 510, and this is inconvenient. This makes it disadvantageously difficult to improve light use efficiency.

A possible method of dealing with such inconveniences is to form a surface of the light guide plate on which light is incident to be perpendicular with respect to an LED optical axis.

FIG. 22 is a top view showing a configuration of a backlight device that is capable of reducing reflection of LED light on a surface of a light guide plate, an aspect ratio (length of a long side:length of a short side) of the light guide plate being approximately 1:1. FIG. 23 is a top view of the light guide plate of the backlight device shown in FIG. 22, showing a light emitting region which emits light by being irradiated with light from an LED. FIG. 24 is a top view of the light guide plate of the backlight device shown in FIG. 22, showing light emitting regions which emit light by being irradiated with light from four LEDs. FIG. 25 is a top view of the light guide plate of the backlight device shown in FIG. 22, showing an effective light emitting region of the light guide plate.

As shown in FIG. 22, a backlight device 601 includes a light guide plate (a light guide member) 610 which is substantially square shaped and LEDs (point light sources) 620 which are disposed at four corners of the light guide plate 610 to face the corners. In the backlight device 601, the LEDs 620 are placed such that a center of the light guide plate 610 (a center O601 of a later-described effective light emitting region S601 (see FIG. 25)) is located on optical axes L601 of the LEDs 620. In addition, in the four corners of the light guide plate 610, light incident surfaces 610a are formed to be parallel to light emitting surfaces 620a of the LEDs 620) (that is, to be perpendicular to the optical axes L601 of the LEDs 620). With this configuration, it is possible to reduce reflection of LED light emitted from the LEDs 620 on surfaces (the light incident surfaces 610a) of the light guide plate 610, to thereby improve light use efficiency.

The light guide plate 610 is typically formed of an acrylic resin, a polycarbonate resin, or the like. Thus, in the backlight device 601 shown in FIG. 22, a spread angle with which the light emitted from the LEDs 620 spreads on entering the light guide plate 610 is smaller than 90°.

Specifically, a refraction index of an acrylic resin is approximately 1.49. Thus, in a case in which the light guide plate 610 is formed by using an acrylic resin, even if a spread angle of light at the time of being emitted from the LEDs 620 is set to, for example, 178°, the spread angle of the light at which it spreads on entering the light guide plate 610 is approximately 84° according to Snell's law. A refraction index of a polycarbonate resin is approximately 1.59. Thus, in a case in which the light guide plate 610 is formed by using a polycarbonate resin, even if the spread angle of the light at the time of being emitted from the LEDs 620 is set to, for example, 178°, a spread angle of the light at which it spreads on entering the light guide plate 610 is approximately 78° according to Snell's law.

As a result, a light emitting region R601 of the light guide plate 610 which emits light by being irradiated with light from one of the LEDs 620 (the one at the top left in FIG. 23) is as shown as a hatching region in FIG. 23. And, in the backlight device 601, in which the LEDs 620 are disposed at the four corners of the light guide plate 610 as shown in FIG. 24, the entire light guide plate 610 is a light emitting region. Incidentally, in FIG. 24, boundary surfaces of the light emitting regions that emit light by being irradiated with light from the LEDs 620 are indicated by lines of as many different types to help distinguish which of the light emitting regions corresponds to which of the LEDs 620.

In addition, with the backlight device 601, in a case in which, as shown in FIG. 25, the effective light emitting region S601 of the light guide plate 610 corresponding to a display region of a display panel (not shown) is a square-shaped region (a hatching region enclosed in a bold line frame in FIG. 25) defined by lines connecting centers of the light incident surfaces 610a of the light guide plate 610, the effective light emitting region S601 of the light guide plate 610 is maximum.

FIG. 27 is a top view showing a configuration of a backlight device that is capable of reducing reflection of LED light on a surface of a light guide plate, an aspect ratio (length of a long side:length of a short side) of the light guide plate being approximately 4:3. FIG. 28 is a top view of the light guide plate of the backlight device shown in FIG. 27, showing a light emitting region that emits light by being irradiated with light from an LED. FIG. 29 is a top view showing an effective light emitting region of the light guide plate of the backlight device shown in FIG. 27.

As shown in FIG. 27, a backlight device 701 includes a light guide plate (a light guide member) 710 which is substantially rectangular and LEDs (point light sources) 720 which are disposed at four corners of the light guide plate 710 to face the corners. In the backlight device 701, the LEDs 720 are placed such that a center of the light guide plate 710 (a center O701 of a later-described effective light emitting region S701 (see FIG. 29)) is located on optical axes L701 of the LEDs 720. In addition, in the four corners of the light guide plate 710, light incident surfaces 710a are formed to be parallel to light emitting surfaces 720a of the LEDs 720) (that is, to be perpendicular to the optical axes L701 of the LEDs 720). With this configuration, it is possible to reduce reflection of LED light emitted from the LEDs 720 on the surfaces (the light incident surfaces 710a) of the light guide plate 710, to thereby improve light use efficiency.

In the backlight device 701, a light emitting region R701 of the light guide plate 710 which emits light by being irradiated with light from one of the LEDs 720 (the one at the top left in FIG. 28) is as shown as a hatching region in FIG. 28. And, in the backlight device 701, as shown in FIG. 27, as in the above-described backlight device 601, the entire light guide plate 710 is a light emitting region. Incidentally, in FIG. 27, the light emitting regions that emit light by being irradiated with light from the LEDs 720 are indicated by lines of as many different types to help distinguish which of the light emitting regions corresponds to which of the LEDs 720.

In addition, with the backlight device 701, in a case in which, as shown in FIG. 29, the effective light emitting region S701 of the light guide plate 710 corresponding to a display region of a display panel (not shown) is a rectangular region (a hatching region enclosed in a bold line frame in FIG. 29) that does not include the light incident surfaces 710a, the effective light emitting region S701 of the light guide plate 710 is maximum.

FIG. 32 is a top view showing a configuration of a backlight device that is capable of reducing reflection of LED light on a surface of a light guide plate, the backlight device having LEDs disposed at two adjacent corners of the light guide plate such that the LEDs face the two adjacent corners. FIG. 33 is a top view of the light guide plate of the backlight device shown in FIG. 32, showing a light emitting region that emits light by being irradiated with light from an LED. FIG. 34 is a top view showing a non-light-emitting region of the light guide plate of the backlight device shown in FIG. 32. FIG. 35 is a top view showing an effective light emitting region of the light guide plate of the backlight device shown in FIG. 32.

As shown in FIG. 32, a backlight device 801 includes a light guide plate (a light guide member) 810 which is substantially rectangular and LEDs (point light sources) 820 which are disposed at two adjacent corners of the light guide plate 810 such that the LEDs 820 face the two adjacent corners. In the backlight device 801, the LEDs 820 are placed such that a center O801 of a later-described effective light emitting region S801 (see FIG. 35) is located on optical axes L801 of the LEDs 820. In addition, in the two corners of the light guide plate 810, light incident surfaces 810a are formed to be parallel to light emitting surfaces 820a of the LEDs 820 (that is, to be perpendicular to the optical axes L801 of the LEDs 820). With this configuration, it is possible to reduce reflection of light emitted from the LEDs 820 on the surfaces (the light incident surfaces 810a) of the light guide plate 810, to thereby improve light use efficiency.

In the backlight device 801, a light emitting region R801 of the light guide plate 810 which emits light by being irradiated with light from one of the LEDs 820 (the one at the top left in FIG. 33) is as shown as a hatching region in FIG. 33. And, with the backlight device 801, where the LEDs 820 are disposed only at two corners of the light guide plate 810, a region excluding a hatching region (a non-light-emitting region R802) in FIG. 34 is the light emitting region. Incidentally, in FIG. 34, boundary surfaces of the light emitting regions that emit light by being irradiated with light from the LEDs 820 are indicated by lines of as many different types to help distinguish which of the light emitting regions corresponds to which of the LEDs 820.

In addition, with the backlight device 801, in a case in which, as shown in FIG. 35, the effective light emitting region S801 of the light guide plate 810 corresponding to a display region of a display panel (not shown) is a rectangular region (a hatching region enclosed in a bold line frame in FIG. 35) that does not include the light incident surfaces 810a, the effective light emitting region S801 of the light guide plate 810 is maximum.

Examples of backlight devices capable of reducing reflection of light from point light sources on a surface of a light guide member include the backlight devices disclosed in Patent Literatures 1 and 2.

### CITATION LIST

### Patent Literature

Patent Literature 1: JP-A-H11-133425

Patent Literature 2: JP-A-2001-215338

### SUMMARY OF INVENTION

### Technical Problem

With the backlight device 601 shown in FIG. 22, however, since a region R602 (a hatching region in FIG. 26) which is a region other than the effective light emitting region S601 of the light guide plate 610 also emits light, it is difficult to improve light use efficiency.

In addition, the backlight device 601 suffers a problem where the existence of the region R602 (the hatching region in FIG. 26) which is a region other than the effective light emitting region S601 of the light guide plate 610 makes it difficult to make the light guide plate 610 compact (resource saving) and lightweight.

With the backlight device 701 shown in FIG. 27, where a region R702 (a hatching region in FIG. 30) which is a region other than the effective light emitting region S701 of the light guide plate 710 also emits light as in the case with the backlight device 601, it is difficult to further improve light use efficiency.

In addition, as in the case with the backlight device 601, the backlight device 701 suffers a problem where the existence of the region R702 (the hatching region in FIG. 30) which is a region other than the effective light emitting region S701 of the light guide plate 710 makes it difficult to make the light guide plate 710 compact and lightweight.

Furthermore, in the backlight device 701, a region R703 (the hatching region in FIG. 31) which is not irradiated with light from either of two adjacent LEDs 720 and the effective light emitting region S701 (see FIG. 29) overlap each other. The region R703 (the hatching region in FIG. 31), which is not irradiated with light from either of two adjacent LEDs 720 and thus is not as bright as the other regions, is liable to be recognized as uneven brightness by a viewer. Note that it is more difficult to make the light guide plate 710 compact and lightweight if the light guide plate 710 is formed such that the region R703 which is not irradiated with light from either of two adjacent LEDs 720 and the effective light emitting region S701 do not overlap each other.

In addition, as in the cases with the backlight devices 601 and 701, the backlight device 801 shown in FIG. 32 suffers a problem where the existence of a region R803 (the hatching region in FIG. 36) which is a region other than the effective light emitting region S801 of the light guide plate 810 makes it difficult to make the light guide plate 810 compact and lightweight.

Furthermore, in the backlight device 801, as in the case with the backlight device 701, a region R802 (the hatching region in FIG. 34) which is not irradiated with light from either of two adjacent LEDs 820 and the effective light emitting region S801 (see FIG. 35) overlap each other. Thus, the region R802 (the hatching region in FIG. 34), which is not irradiated with light from either of the two adjacent LEDs 820, is liable to be recognized as uneven brightness by a viewer.

As described hereinabove, the backlight devices 601, 701, and 801 all suffer the problem where it is difficult to make the light guide plate compact and lightweight.

The present invention has been made to solve the above problems, and an object of the present invention is to provide a backlight device and a display device that are capable of both improving light use efficiency and achieving a compact and lightweight light guide member.

### Solution to Problem

To achieve the above object, according to a first aspect of the present invention, a backlight device includes a light guide member and a plurality of point light sources which irradiate the light guide member with light. Here, the light guide member includes a plurality of light incident surfaces, the light incident surfaces being formed in at least two adjacent corners thereof such that the point light sources are disposed to face the light incident surfaces, and a plurality of side surfaces. And, at least one of the side surfaces between adjacent ones of the light incident surfaces is formed in a depressed shape.

In the backlight device according to the first aspect, as described above, the light guide member includes the plurality of light incident surfaces, and the point light sources are disposed to face the light incident surfaces. With this configuration, it is possible to reduce reflection of light emitted from the point light sources on surfaces (the light incident surfaces) of the light guide member, and this makes it possible to improve light use efficiency.

Furthermore, with the backlight device according to the first aspect, by forming, as described above, at least one of the side surfaces between adjacent ones of the light incident surfaces in a depressed shape, it is possible to achieve a compact (resource saving) and lightweight light guide member.

Note that, in a case in which no side surface of the light guide member is formed in a depressed shape, if a light incident surface is formed in a corner of the light guide member, there appears, in the light guide member, a region other than the effective light emitting region (that is, a region that does not contribute to illumination of the display panel). Furthermore, if the effective light emitting region is maximized, there appears a region other than the effective light emitting region (that is, a region that does not contribute to illumination of the display panel) around at least one side surface between adjacent ones of the light emitting surfaces. Thus, even if at least one of the side surfaces between adjacent ones of the light incident surfaces is formed in a depressed shape, the effective light emitting region of the light guide member is not reduced. That is, an effective light emitting region of the same size can be obtained without making the light guide member larger.

Moreover, with the backlight device according to the first aspect, since at least one of the side surfaces between adjacent ones of the light incident surfaces is formed in a depressed shape, it is possible to reduce emission of light from a region other than the effective light emitting region of the light guide member. This makes it possible to further improve light use efficiency.

In the backlight device according to the first aspect described above, it is preferable that the plurality of side surfaces include a pair of first side surfaces which face each other and a pair of second side surfaces which are disposed along a direction that crosses the first side surfaces, that a length of the first side surfaces be not longer than a length of the second side surfaces, and that at least one of the pair of first side surfaces be located between the plurality of light incident surfaces and formed in a depressed shape. With this configuration, in a case, for example, in which the light guide member is formed in a substantially rectangular shape, a side surface (a first side surface) along a short side of the light guide member is formed in a depressed shape. Here, in order to maximize the effective light emitting region in the case in which the light guide member is formed substantially rectangular, it is necessary to form a side surface along a short side of the light guide member in a depressed shape, without forming a side surface (a second side surface) on a long side of the light guide member in a depressed shape. Thus, by forming, as described above, at least one of the pair of first side surfaces in a depressed shape, it is possible to maximize the effective light emitting region. That is, an effective light emitting region of the same size can be obtained with a smaller light guide member. As a result, a compact and lightweight light guide member can be obtained.

In the backlight device in which the plurality of side surfaces include a pair of first side surfaces and a pair of second side surfaces, it is preferable that the length of the first side surfaces be shorter than the length of the second side surfaces, that the light guide member include an effective light emitting region corresponding to a display region of a display panel, and that a center of the effective light emitting region of the light guide member be disposed a predetermined distance away from optical axes of the point light sources. With this configuration, in contrast to a case in which the center of the effective light emitting region of the light guide member is located on the optical axes of the point light sources, it is possible to reduce overlap of a region that is not irradiated with light from either of two adjacent point light sources and the effective light emitting region, and thus it is possible to reduce occurrence of uneven brightness in the effective light emitting region. Also, since there is no need of making the light guide member larger in order to prevent the region that is not irradiated with light from either of two adjacent point light sources and the effective light emitting region from overlapping each other, it is possible to reduce increase in size and weight of the light guide member.

In the backlight device in which the plurality of side surfaces include the pair of first side surfaces and the pair of second light sources, it is preferable that the light incident surfaces be formed in four corners of the light guide member, and that the pair of first side surfaces be both formed in a depressed shape. With this configuration, in a case in which the point light sources are disposed at the four corners of the light guide member, it is possible to both maximize the effective light emitting region and make the light guide member compact and lightweight.

In the backlight device in which the plurality of side surfaces include the pair of first side surfaces and the pair of second light sources, it is preferable that the light incident surfaces be formed in two adjacent corners of the light guide member, and that only one of the pair of first side surfaces be formed in a depressed shape. With this configuration, in a case in which the point light sources are disposed at two adjacent corners of the light guide member, it is possible to both maximize the effective light emitting region and make the light guide member compact and lightweight. In addition, since the number of point light sources can be reduced in comparison with the case in which the point light sources are disposed at the four corners of the light guide member, it is possible to achieve a compact and lightweight backlight device.

In the backlight device according to the first aspect, it is preferable that an angle formed by two of the side surfaces that are adjacent to the light incident surfaces be substantially as large as a spread angle at which light from the point light sources spreads on entering the light guide member. With this configuration, it is possible to reduce appearance of a useless region (that does not contribute to illumination of the display panel) through which light emitted from the point light sources does not pass, and thus it is easy to achieve a compact and lightweight light guide member.

In the backlight device according to the first aspect, it is preferable that the light guide member include an effective light emitting region corresponding to a display region of a display panel, and that a side surface among the side surfaces that is formed in a depressed shape have a function of reflecting light that enters the light guide member to the effective light emitting region side. With this configuration, it is possible to reflect, to the side of the effective light emitting region of the light guide member, light that travels toward the side surface that is formed in a depressed shape after entering the light guide member, and thus to reduce loss of light. That is, it is possible to reduce degradation of light use efficiency.

In the backlight device in which a side surface among the side surfaces that is formed in a depressed shape has a function of reflecting light that enters the light guide member to the effective light emitting region side, it is preferable that a prism be formed on the side surface that is formed in the depressed shape. With this configuration, in comparison with a case in which no prism is formed on the side surface that is formed in a depressed shape, it is easier to reflect the light to an inside (a side surface opposite to the side surface formed in a depressed shape) of the light guide member. This makes it possible to achieve uniform emission of light from the light guide member and to achieve more uniform brightness of the display panel as well.

In the backlight device according to the first aspect, it is preferable that the light incident surfaces be formed as a flat surface or a curved surface. With this configuration, it is possible to easily reduce reflection of light emitted from the point light sources on the surfaces (the light incident surfaces) of the light guide member, and this makes it easy to improve light use efficiency.

In the backlight device according to the first aspect, it is preferable that a side surface among the side surfaces that is formed in a depressed shape include a plurality of flat surface portions or at least one curved surface portion. With this configuration, it is easy to form a side surface in a depressed shape.

According to a second aspect of the present invention, a display device includes any one of the above-configured backlight devices and a display panel which is illuminated by the backlight device. With this configuration, it is possible to obtain a display device that is capable of both improving light use efficiency and making the light guide member compact and lightweight.

### Advantageous Effects of Invention

As described hereinabove, according to the present invention, it is possible to obtain a display device capable of both improving light use efficiency and making the light guide member compact and lightweight.

### BRIEF DESCRIPTION OF DRAWINGS

FIG. 1 is a side view schematically showing a configuration of a liquid crystal display device according to a first embodiment of the present invention;

FIG. 2 is a top view showing a configuration of a backlight device according to the first embodiment of the present invention shown in FIG. 1;

FIG. 3 is a top view of a light guide plate of the backlight device according to the first embodiment of the present invention shown in FIG. 1, showing a light emitting region that emits light by being irradiated with light from an LED;

FIG. 4 is a top view of the light guide plate of the backlight device according to the first embodiment of the present invention shown in FIG. 1, showing a region that is not irradiated with light from either of two adjacent LEDs;

FIG. 5 is a top view of the light guide plate of the backlight device according to the first embodiment of the present invention shown in FIG. 1, showing light emitting regions which emit light by being irradiated with light from four LEDs;

FIG. 6 is a top view of the light guide plate of the backlight device according to the first embodiment of the present invention shown in FIG. 1, showing an effective light emitting region of the light guide plate;

FIG. 7 is a top view showing a configuration of a backlight device according to a second embodiment of the present invention;

FIG. 8 is a top view of a light guide plate of the backlight device according to the second embodiment of the present invention shown in FIG. 7, showing a light emitting region that emits light by being irradiated with light from an LED;

FIG. 9 is a top view of the light guide plate of the backlight device according to the second embodiment of the present invention shown in FIG. 7, showing a region that is not irradiated with light from either of two adjacent LEDs;

FIG. 10 is a top view of the light guide plate of the backlight device according to the second embodiment of the present invention shown in FIG. 7, showing light emitting regions which emit light by being irradiated with light from four LEDs;

FIG. 11 is a top view of the light guide plate of the backlight device according to the second embodiment of the present invention shown in FIG. 7, showing an effective light emitting region of the light guide plate;

FIG. 12 is a top view showing a configuration of a backlight device according to a third embodiment of the present invention;

FIG. 13 is a top view of a light guide plate of the backlight device according to the third embodiment of the present invention shown in FIG. 12, showing an effective light emitting region of the light guide plate;

FIG. 14 is a top view of the light guide plate of the backlight device according to the third embodiment of the present invention shown in FIG. 12, showing a light emitting region of the light guide plate that emits light by being irradiated with light from an LED, on the assumption that the light guide plate is not formed in a depressed shape;

FIG. 15 is a top view of the light guide plate of the backlight device according to the third embodiment of the present invention shown in FIG. 12, showing a light emitting region that emits light by being irradiated with light from an LED;

FIG. 16 is a top view of the light guide plate of the backlight device according to the third embodiment of the present invention shown in FIG. 12, showing light emitting regions which emit light by being irradiated with light from two LEDs;

FIG. 17 is a top view showing a configuration of a backlight device according to a fourth embodiment of the present invention;

FIG. 18 is an enlarged top view of a light guide plate of the backlight device according to the fourth embodiment of the present invention shown in FIG. 17 for illustrating a prism of the light guide plate;

FIG. 19 is a top view showing a configuration of a light guide plate of a backlight device according to a first modified example of the present invention;

FIG. 20 is an enlarged top view showing a configuration of a light guide plate of a backlight device according to a second modified example of the present invention;

FIG. 21 is a top view showing a configuration of a backlight device according to a conventional example where LEDs are disposed at the corners of a light guide plate;

FIG. 22 is a top view showing a configuration of a backlight device that is capable of reducing reflection of LED light on surfaces of a light guide plate, an aspect ratio (length of a long side:length of a short side) of the light guide plate being approximately 1:1;

FIG. 23 is a top view of the light guide plate of the backlight device shown in FIG. 22, showing a light emitting region that emits light by being irradiated with light from an LED;

FIG. 24 is a top view of the light guide plate of the backlight device shown in FIG. 22, showing light emitting regions which emit light by being irradiated with light from four LEDs;

FIG. 25 is a top view of the light guide plate of the backlight device shown in FIG. 22, showing an effective light emitting region of the light guide plate;

FIG. 26 is a top view of the light guide plate of the backlight device shown in FIG. 22, showing a region other than the effective light emitting region of the light guide plate;

FIG. 27 is a top view showing a configuration of a backlight device that is capable of reducing reflection of LED light on surfaces of a light guide plate, an aspect ratio (length of a long side:length of a short side) of the light guide plate being approximately 4:3;

FIG. 28 is a top view of the light guide plate of the backlight device shown in FIG. 27, showing a light emitting region that emits light by being irradiated with light from an LED;

FIG. 29 is a top view of the light guide plate of the backlight device shown in FIG. 27, showing an effective light emitting region of the light guide plate;

FIG. 30 is a view of the light guide plate of the backlight device shown in FIG. 27, showing a region other than the effective light emitting region of the light guide plate;

FIG. 31 is a top view of the light guide plate of the backlight device shown in FIG. 27, showing a region that is not irradiated with light from either of two adjacent LEDs;

FIG. 32 is a top view showing a configuration of a backlight device that is capable of reducing reflection of LED light on surfaces of a light guide plate, the backlight device having LEDs disposed at two adjacent corners of the light guide plate;

FIG. 33 is a top view of the light guide plate of the backlight device shown in FIG. 32, showing a light emitting region that emits light by being irradiated with light from an LED;

FIG. 34 is a top view of the light guide plate of the backlight device shown in FIG. 32, showing a non-light-emitting region of the light guide plate;

FIG. 35 is a top view of the light guide plate of the backlight device shown in FIG. 32, showing an effective light emitting region of the light guide plate; and

FIG. 36 is a top view of the light guide plate of the backlight device shown in FIG. 32, showing a region other than the effective light emitting region of the light guide plate.

### DESCRIPTION OF EMBODIMENTS

Embodiments of the present invention will be described below with reference to the accompanying drawings. In some of the top views, some portions are indicated by hatching for ease of understanding.

### First Embodiment

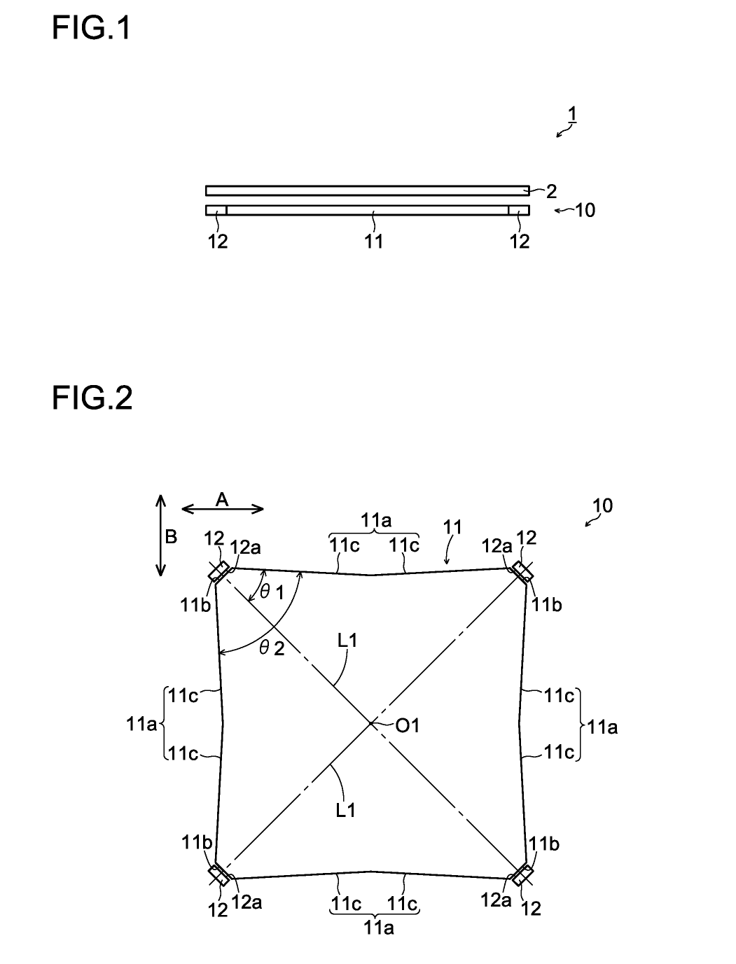

With reference to FIGS. 1 to 6, a description will be given of a liquid crystal display device 1 provided with a backlight device 10 according to a first embodiment of the present invention.

The liquid crystal display device 1 according to the first embodiment of the present invention is applicable to portable devices such as mobile phones, for example, and as shown in FIG. 1, the liquid crystal display device 1 is provided with a liquid crystal display panel 2 and a backlight device 10 which is disposed on a rear surface side of the liquid crystal display panel 2. With respect to the first embodiment, descriptions will deal with a case where the aspect ratio (length of a long side:length of a short side) of a display region (not shown) of the liquid crystal display panel 2 is approximately 1:1. The liquid crystal display device 1 is an example of the “display device” of the present invention, and the liquid crystal display panel 2 is an example of the “display panel” of the present invention.

The liquid crystal display panel 2 is formed of two glass substrates which hold a liquid crystal layer (not shown) in between. The liquid crystal display panel 2 functions as a display panel by being illuminated by the backlight device 10.

As shown in FIG. 2, a backlight device 10 is provided with a light guide plate 11, which is substantially square shaped, and four LEDs 12 which are disposed at four corners of the light guide plate 11 to face the corners. The backlight device 10 may be provided with components such as an optical sheet, a reflection sheet, and a circuit board, which are not illustrated. The light guide plate 11 is an example of the “light guide member” of the present invention, and the LEDs 12 are an example of the “point light source” of the present invention.

In the backlight device 10, the LEDs 12 are each disposed such that a center of the light guide plate 11 (a center O1 of a later-described effective light emitting region S1 (see FIG. 6) of the light guide plate 11) is located on optical axes (center lines) L1 of the LEDs 12.

The light guide plate 11 is formed of, for example, an acrylic resin having a refraction index of approximately 1.49. The light guide plate 11 includes four side surfaces 11a, and four light incident surfaces 11b formed in four corners thereof (where adjacent ones of the side surfaces 11a are connected to each other). The side surfaces 11a are an example of a “side surface located between adjacent light incident surfaces,” a “first side surface,” and a “second side surface.”

The light incident surfaces 11b are formed to be inclined with respect to the side surfaces 11a and parallel to light emitting surfaces 12a of (that is, perpendicular to optical axes L1 of) the LEDs 12. And, the light emitting surfaces 12a are disposed to face the light incident surfaces 11b.

The side surfaces 11a are located between two adjacent ones of the light incident surfaces 11b. The four side surfaces 11a include a pair of side surfaces 11a that are disposed to face each other in an A-direction and another pair of side surfaces 11a that are disposed to face each other in a B-direction which is perpendicular to (which crosses) the A-direction. Note that, in the first embodiment, the pair of side surfaces 11a which are disposed to face each other in the A-direction and the pair of side surfaces 11a which are disposed to face each other in the B-direction are all formed to have a same length and a same shape.

Here, in the first embodiment, the side surfaces 11a of the light guide plate 11 are each formed in a depressed shape that is depressed toward a center of the light guide plate 11 (a center O1 of a later-described effective light emitting region of the light guide plate 11). The side surfaces 11a are formed of a plurality of (two) flat surface portions 11c.

The light guide plate 11 can be formed by, for example, injection molding which is performed by using an injection mold, and the depressed shape (the flat surface portions 11c) of the side surfaces 11a can also be formed simultaneously in the injection molding. Incidentally, the depressed shape (the flat surface portions 11c) of the side surfaces 11a may be formed by cutting.

Furthermore, in the first embodiment, the flat surface portions 11c are formed such that an angle θ1 formed by one of the flat surface portions 11c (the side surfaces 11a) and an optical axis L1 of an adjacent one of the LEDs 12 is approximately 42°.

Here, a spread angle of light from the LEDs 12 at which the light spreads on entering the light guide plate 11 is smaller than 90°. Specifically, since the refraction index of the light guide plate 11 (made of an acrylic resin) is approximately 1.49, even if a spread angle of light at the time of being emitted from the LEDs 12 is set to, for example, 178°, a spread angle of the light at which the light spreads on entering the light guide plate 11 is approximately 84° according to Snell's law.

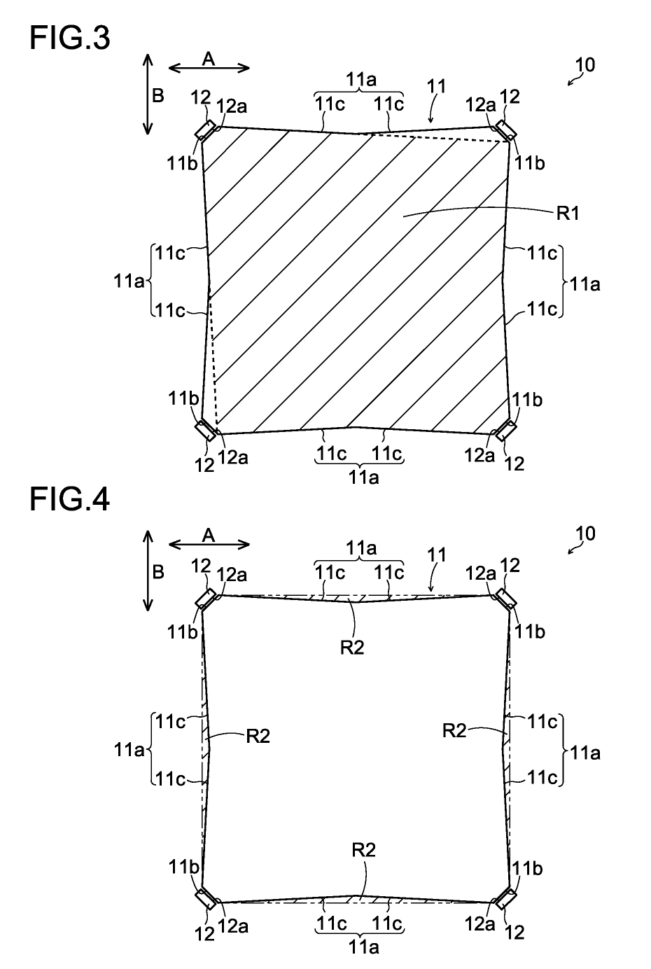

That is, in the first embodiment, an angle θ2 (=θ1×2) formed by any two of the flat surface portions 11c (the side surfaces 11a) that are connected to a same one of the light incident surfaces 11b is substantially as large as the spread angle (approximately 84°) at which light from the LEDs 12 spreads on entering the light guide plate 11. Note that, in the light guide plate 11, a light emitting region R1 which emits light by being irradiated with light from one of the LEDs 12 (the one at the top left in FIG. 3) is as shown as a hatching region in FIG. 3.

Furthermore, as shown in FIG. 3, the flat surface portions 11c (the side surfaces 11a) are each formed to coincide with part of a boundary surface of a light emitting region R1 that emits light by being irradiated with light from an adjacent one of the LEDs 12. In other words, the side surfaces 11a are each formed in a depressed shape so as to coincide with a boundary surface of a region R2 (a hatching region in FIG. 4) which is a region that is not irradiated with light from either of two adjacent ones of the LEDs 12 (a region through which light from the LEDs 12 does not pass). The hatching regions (regions R2) in FIG. 4 are regions that would not be irradiated with light from either of two adjacent ones of the LEDs 12 even if the side surfaces 11a were not formed in a depressed shape, the regions R2 not contributing to the illumination of the liquid crystal display panel 2.

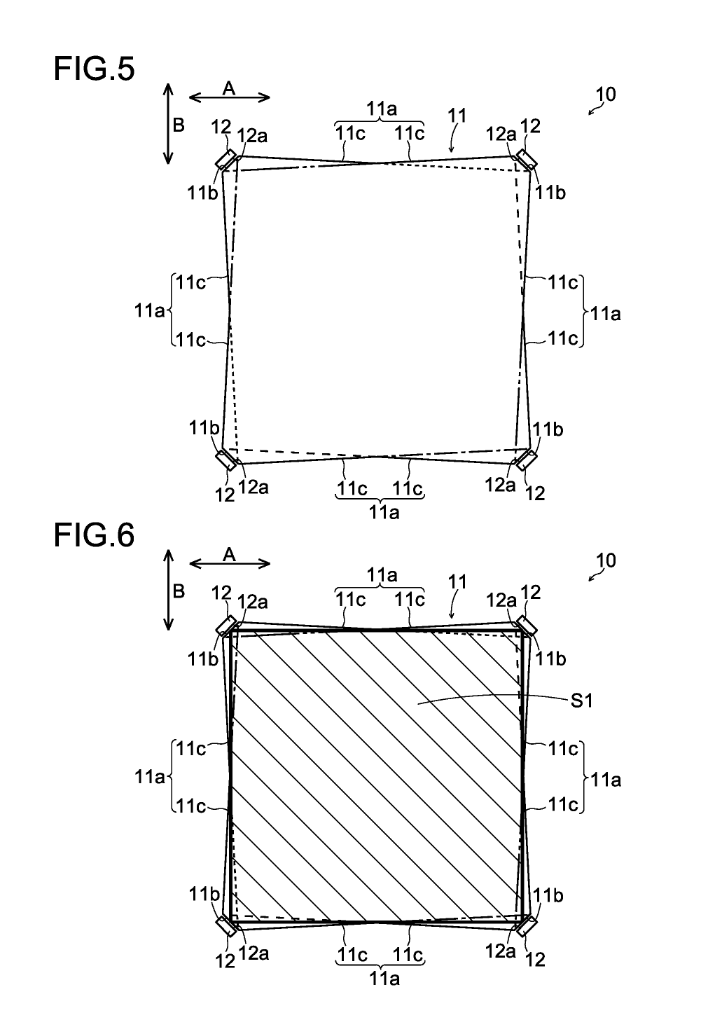

Moreover, in the first embodiment, since the LEDs 12 are disposed at the four corners of the light guide plate 11 as shown in FIG. 5, the entire light guide plate 11 is a light emitting region. Incidentally, in FIG. 5, the boundary surfaces of regions that emit light by being irradiated with light from the LEDs 12 are indicated by lines of as many different types to help distinguish which of the light emitting regions corresponds to which of the LEDs 12.

In addition, in the first embodiment, since the effective light emitting region S1 of the light guide plate 11 corresponding to the display region (not shown) of the liquid crystal display panel 2 is a square-shaped region (a hatching region enclosed in a bold line flame in FIG. 6) that is defined by lines connecting centers of the light incident surfaces 11b of the light guide plate 11, and in this case, the effective light emitting region S1 is maximum. Besides, an aspect ratio (length of a long side:length of a short side) of the effective light emitting region S1 of the light guide plate 11 is approximately 1:1.

In the first embodiment, as described above, the light guide plate 11 is provided with a plurality of light incident surfaces 11b, and the LEDs 12 are disposed to face the light incident surfaces 11b. With this configuration, it is possible to reduce reflection of light emitted from the LEDs 12 on surfaces (the light incident surfaces 11b) of the light guide plate 11, and this makes it possible to improve light use efficiency.

Furthermore, in the first embodiment, it is possible to make the light guide plate 11 compact (resource saving) and lightweight by forming the side surfaces 11a, which are located between two adjacent ones of the light incident surfaces 11b, in a depressed shape as described above.

Note that, in a case in which the light incident surfaces 11b are formed in the corners of the light guide plate 11 without forming the side surfaces 11a of the light guide plate 11 in a depressed shape, the regions R2 (which do not contribute to the illumination of the liquid crystal display panel 2), which are regions that are not irradiated with light from either of two adjacent ones of the LEDs 12, appear in the light guide plate 11. Furthermore, when the effective light emitting region S1 is maximum, the regions R2 (which do not contribute to the illumination of the liquid crystal display panel 2), which are regions that are not irradiated with light from either of two adjacent ones of the LEDs 12, appear around the side surfaces 11a which are located between two adjacent ones of the light incident surfaces 11b. Thus, even if the side surfaces 11a of the light guide plate 11 are formed in depressed shapes by omitting the regions which are not irradiated with light from either of two adjacent ones of the LEDs 12, the effective light emitting region S1 of the light guide plate 11 is not reduced in size. That is, the effective light emitting region S1 of the same size can be obtained without increasing the size of the light guide plate 11.

Furthermore, in the first embodiment, since the side surfaces 11a of the light guide plate 11 are formed in a depressed shape, it is possible to reduce emission of light from regions other than the effective light emitting region S1. This makes it possible to further improve light use efficiency.

Moreover, in the first embodiment, by forming all of the side surfaces 11a in a depressed shape as described above, it is possible to make the light guide plate 11 more compact and lightweight while maximizing the effective light emitting region S1.

Besides, in the first embodiment, as described above, the angle θ2 formed by any two of the side surfaces 11a that are connected to a same one of the light incident surfaces 11b is substantially as large as the spread angle (approximately 84°) at which light from the LEDs 12 spreads on entering the light guide plate 11. With this configuration, it is possible to reduce appearance of the useless regions R2 (which do not contribute to illumination of the display panel 2) through which light emitted from the LEDs 12 does not pass, and this makes it easy to make the light guide plate 11 compact and lightweight.

In addition, in the first embodiment, as described above, the light incident surfaces 11b are formed as flat surfaces, and this makes it easy to reduce reflection of light emitted from the LEDs 12 on the surfaces (the light incident surfaces 11b) of the light guide plate 11. Thus, it is possible to easily improve light use efficiency.

Also, in the first embodiment, the side surfaces 11a are formed of two flat surface portions 11c as described above, and this makes it easy to form the side surfaces 11a in a depressed shape.

### Second Embodiment

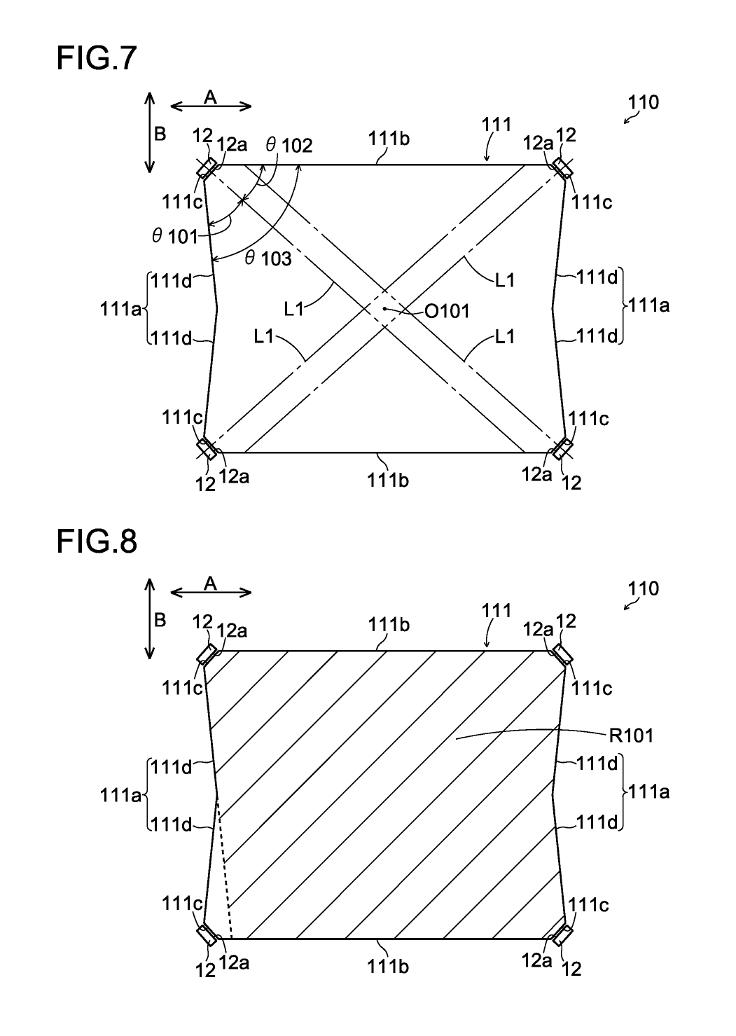

In the second embodiment, with reference to FIGS. 7 to 11, a description will be given of a case in which a light guide plate 111 is formed in a substantially rectangular shape in contrast to the first embodiment.

As shown in FIG. 7, a backlight device 110 according to the second embodiment is provided with the light guide plate 111, which is substantially rectangular, and four LEDs 12 which are disposed at four corners of the light guide plate 111 to face the corners. Here, in the second embodiment, the description will deal with a case where the aspect ratio (length of a long side:length of a short side) of a display region (not shown) of a display panel is 4:3. The light guide plate 111 is an example of the “light guide member” of the present invention.

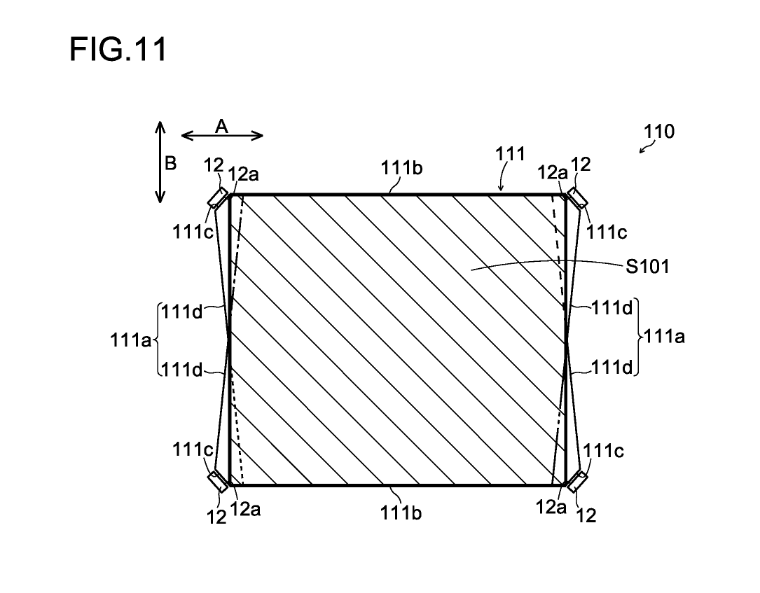

In the second embodiment, the LEDs 12 are each disposed such that a center of the light guide plate 111 (a center O101 of a later-described effective light emitting region S101 (see FIG. 11) of the light guide plate 111) is not located on optical axes L1 of the LEDs 12. In other words, the center O101 of the later-described effective light emitting region S101 is located a predetermined distance away from the optical axes L1 of the LEDs 12.

The light guide plate 111 includes a pair of side surfaces 111a that are located to face each other in an A-direction (a long-side direction), a pair of side surfaces 111b that are located to face each other in a B-direction (a short-side direction) which is perpendicular to the A-direction, and light incident surfaces 111c formed in four corners (at each of which a side surface 111a and a side surface 111b which are adjacent to each other are connected to each other). The side surfaces 111a are an example of the “side surface located between adjacent light incident surfaces” and the “first side surface.” Also, the side surfaces 111b are an example of the “second side surface” of the present invention.

The length of the side surfaces 111a is shorter than that of the side surfaces 111b. The side surfaces 111a form a short-side portion of the light guide plate 111 while the side surfaces 111b form a long-side portion of the light guide plate 111.

Furthermore, in the second embodiment, both of the pair of side surfaces 111a of the light guide plate 111 are formed in a depressed shape which is depressed toward the center of the light guide plate 111 (the center O101 of the later-described effective light emitting region S101 of the light guide plate 111). The side surfaces 111a are formed of a plurality of (two) flat surface portions 111d.

On the other hand, in the second embodiment, the pair of side surfaces 111b of the light guide plate 111 are not formed in a depressed shape.

Moreover, the flat surface portions 111d (the side surfaces 111a) are formed such that an angle θ101 formed by one of the flat surface portions 111d and the optical axis L1 of an adjacent one of the LEDs 12 is approximately 42°. Likewise, the side surfaces 111b are formed such that an angle θ102 that is formed by each of the side surfaces 111b and the optical axis L1 of an adjacent one of the LEDs 12 is approximately 42°.

Thus, like in the first embodiment, an angle θ103 (=θ101+θ102) formed by a flat surface portion 111d (a side surface 111a) and a side surface 111b which are connected to a same one of the light incident surfaces 111c is substantially as large as a spread angle (approximately 84°) at which light emitted from the LEDs 12 spreads on entering the light guide plate 111. Note that, in the light guide plate 111, a light emitting region R101 which emits light by being irradiated with light from one of the LEDs 12 (the one at the top left in FIG. 8) is as shown as a hatching region in FIG. 8.

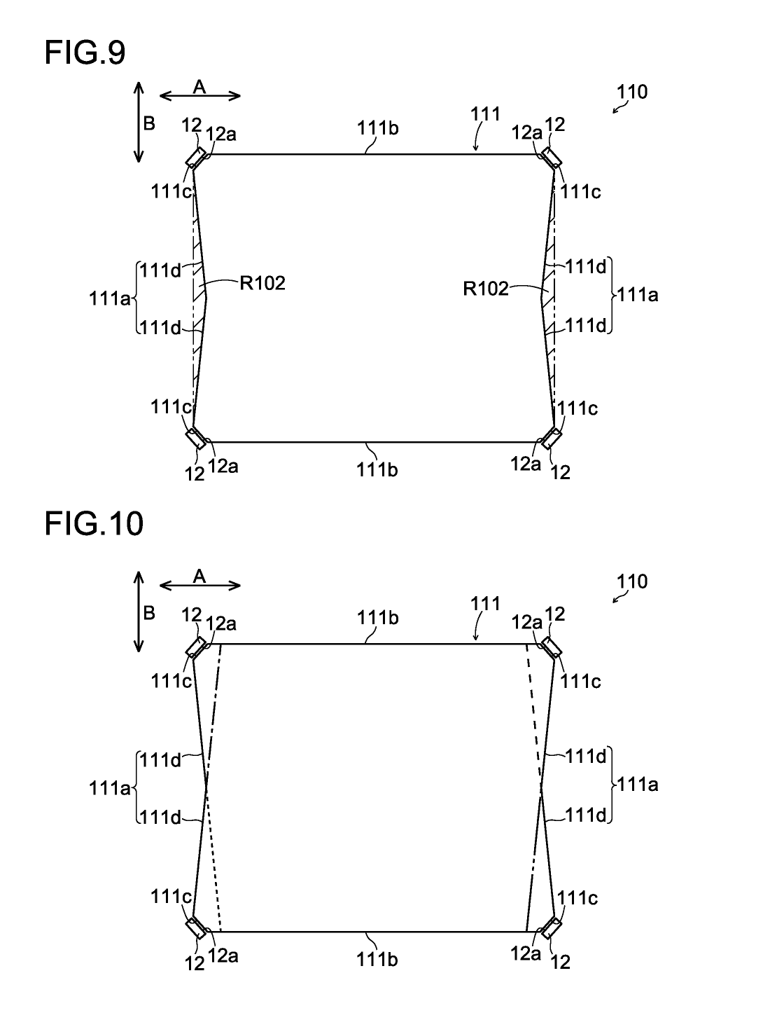

Besides, as shown in FIG. 8, the flat surface portions 111d (the side surfaces 111a) are each formed to coincide with part of a boundary surface of a light emitting region R101 that emits light by being irradiated with light from an adjacent one of the LEDs 12. In other words, the side surfaces 111a are each formed in a depressed shape so as to coincide with a boundary surface of a region R102 (a hatching region in FIG. 9) which is not irradiated with light from either of two adjacent ones of the LEDs 12. Note that the hatching regions (regions R102) in FIG. 9 are regions that are not irradiated with light from either of two adjacent ones of the LEDs 12 even if the side surfaces 111a are not formed in a depressed shape, and the regions R102 do not contribute to illumination of a liquid crystal display panel.

The side surfaces 111b are each formed to coincide with a boundary surface of one of the light emitting regions R101 that emits light by being irradiated with light from an adjacent one of the LEDs 12.

Furthermore, in the second embodiment, since the LEDs 12 are disposed at the four corners of the light guide plate 111 as shown in FIG. 10, the entire light guide plate 111 is a light emitting region. Incidentally, in FIG. 10, the boundary surfaces of the light emitting regions that emit light by being irradiated with light from the LEDs 12 are indicated by lines of as many different types to help distinguish which of the light emitting regions corresponds to which of the LEDs 12.

Moreover, in the second embodiment, as shown in FIG. 11, since the effective light emitting region S101 of the light guide plate 111 corresponding to a display region (not shown) of a liquid crystal display panel is a rectangular region (a hatching region enclosed in a bold line flame in FIG. 11) that does not include the light incident surfaces 111c, and in this case, the effective light emitting region S101 is maximum. An aspect ratio (length of a long side:length of a short side) of the effective light emitting region S101 of the light guide plate 111 is approximately 4:3.

The other features of the second embodiment are similar to those of the first embodiment.

In the second embodiment, as described above, a length of the side surfaces 111a is formed to be shorter than a length of the side surfaces 111b (that is, the light guide plate 111 is formed in a substantially rectangular shape), and the side surfaces 111a are formed in a depressed shape. Here, in order to maximize the effective light emitting region S101 in the case where the light guide member 111 is formed in a substantially rectangular shape, it is necessary to form the side surfaces 111a along the short sides of the light guide member 111 in a depressed shape, without forming the side surfaces 111b along the long sides of the light guide member 111 in a depressed shape. Thus, by forming the side surfaces 111a in a depressed shape without forming the side surfaces 111b in a depressed shape as described above, it is possible to maximize the effective light emitting region S101. That is, the effective light emitting region S101 of the same size can be obtained with a smaller light guide plate 111. As a result, it is possible to make the light guide plate 111 more compact and lightweight.

Besides, in the second embodiment, as described above, the center O101 of the effective light emitting region S101 of the light guide plate 111 is located a predetermined distance away from the optical axes L1 of the LEDs 12. With this configuration, in contrast to a case in which the center O101 of the effective light emitting region S101 of the light guide plate 111 is located on the optical axes L1 of the LEDs 12, it is possible to reduce overlap of the regions (the regions R102) which are not irradiated with light from either of two adjacent ones of the LEDs 12 and the effective light emitting region S101, and this makes it possible to reduce occurrence of uneven brightness in the effective light emitting region S101. Also, since there is no need of making the light guide plate 111 larger in order to prevent the regions (the regions R102) which are not irradiated with light from either of two adjacent ones of the LEDs 12 and the effective light emitting region from overlapping each other, it is possible to reduce increase in size and weight of the light guide plate 111.

The other advantages of the second embodiment are similar to the advantages of the first embodiment.

### Third Embodiment

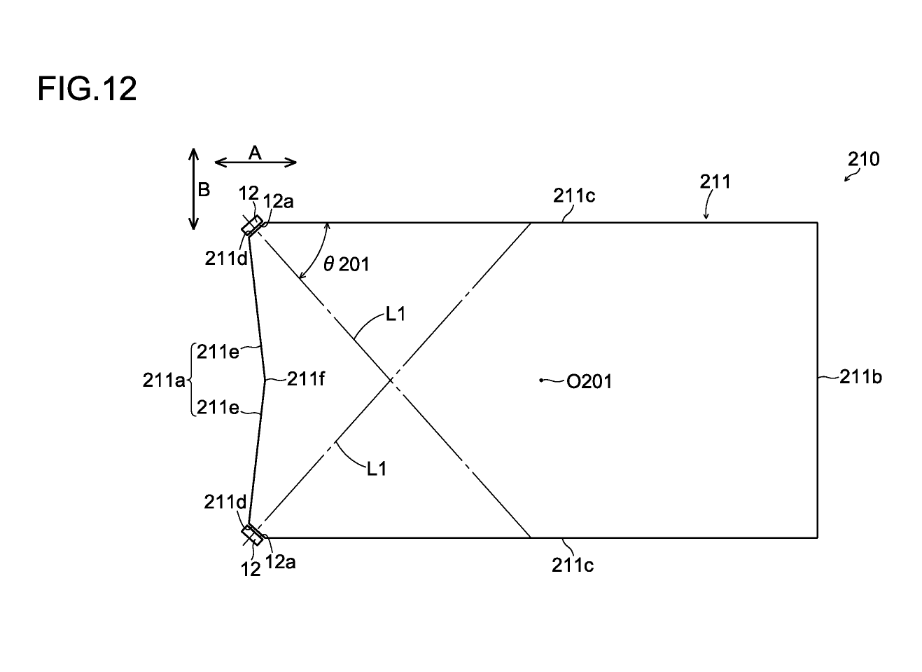

In a third embodiment, with reference to FIGS. 12 to 16, a description will be given of a case in which LEDs 12 are disposed at two corners of a light guide plate 211, in contrast to the first and second embodiments described above.

As shown in FIG. 12, a backlight device 210 according to the third embodiment of the present invention is provided with the light guide plate 211, which is substantially rectangular, and two LEDs 12 which are disposed at two corners of the light guide plate 211 to face the corners. Here, in the third embodiment, the description will deal with a case where the aspect ratio (length of a long side:length of a short side) of a display region (not shown) of a display panel is 16:9. The light guide plate 211 is an example of the “light guide member” of the present invention.

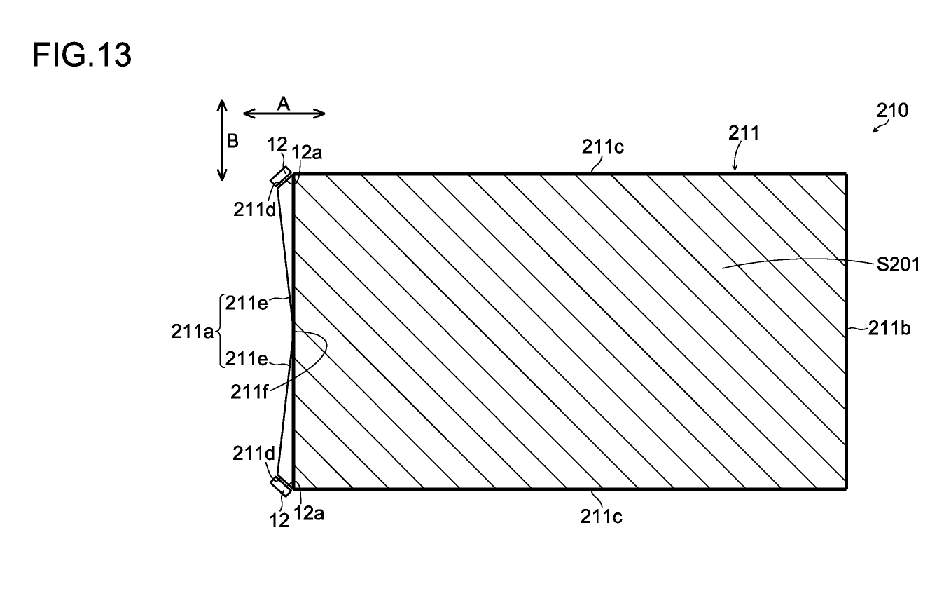

In the third embodiment, the LEDs 12 are each disposed such that a center O201 of a later-described effective light emitting region S201 (see FIG. 13) of the light guide plate 211 is not located on optical axes L1 of the LEDs 12. That is, the center O201 of the later-described effective light emitting region S201 of the light guide plate 211 is located a predetermined distance away from the optical axes L1 of the LEDs 12.

The light guide plate 211 includes a pair of side surfaces 211a and 211b that are located to face each other in an A-direction (a long-side direction), a pair of side surfaces 211c that are located to face each other in a B-direction (a short-side direction) which is perpendicular to the A-direction, and light incident surfaces 211d formed in two adjacent corners of the light guide plate 211. The side surface 211a is an example of the “side surface located between adjacent light incident surfaces” and the “first side surface” of the present invention. The side surface 211b is an example of the “first side surface,” and the side surfaces 211c are an example of the “second side surface” of the present invention.

A length of the side surface 211a and a length of the side surface 211b are shorter than a length of the side surfaces 211c. And, the side surfaces 211a and 211b form a short-side portion of the light guide member 211 while the two side surfaces 211c form a long-side portion of the light guide plate 211.

Here, in the third embodiment, among the side surfaces 211a to 211c, only the side surface 211a, which is located between the two LEDs 12, is formed in a depressed shape that is depressed toward a center of the light guide plate 211 (the center O201 of the later-described effective light emitting region S201 of the light guide plate 211). Furthermore, the side surface 211a is formed of a plurality of (two) flat surface portions 211e.

On the other hand, in the third embodiment, the side surface 211b and the pair of side surfaces 211c of the light guide plate 211 are not formed in a depressed shape.

Moreover, in the third embodiment, as shown in FIG. 13, the effective light emitting region S201 of the light guide plate 211 corresponding to a display region (not shown) of a liquid crystal display panel is a rectangular region (a hatching region enclosed in a bold line frame in FIG. 13) that does not include the light incident surfaces 211d, and in this case, the effective light emitting region S201 is maximum. Besides, an aspect ratio (length of a long side:length of a short side) of the effective light emitting region S201 of the light guide plate 211 is approximately 16:9.

In addition, in the third embodiment, a portion 211f where the two flat surface portions 211e of the side surface 211a cross (are connected to) each other is located in the vicinity of the effective light emitting region S201 or on a boundary surface of the effective light emitting region S201. That is, no part of the side surface 211a formed in a depressed shape exists inside the effective light emitting region S201.

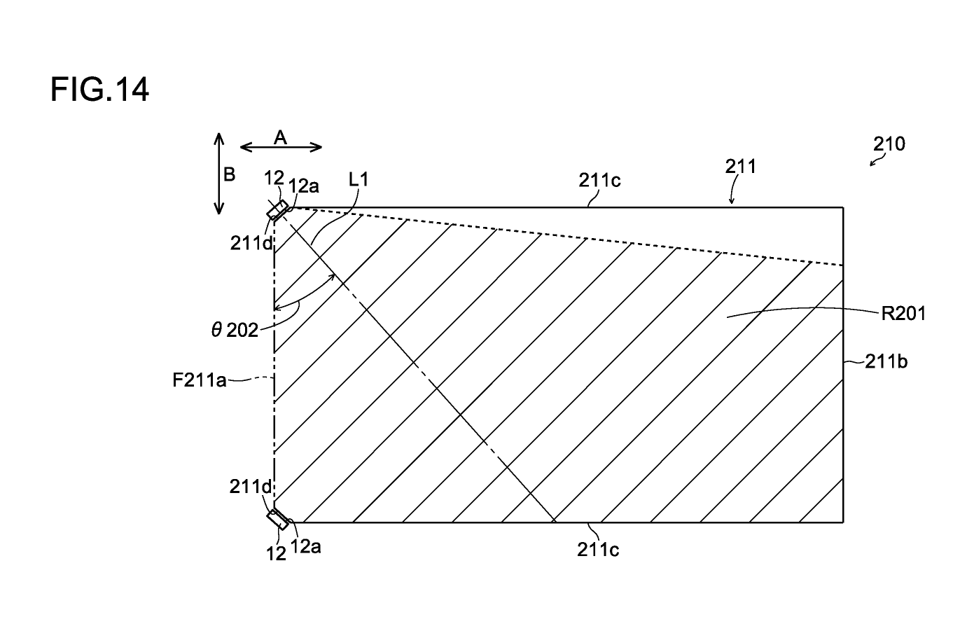

Here, in the third embodiment, as shown in FIG. 12, the LEDs 12 are disposed such that an angle θ201 formed between an optical axis L1 of one of the LEDs 12 and an adjacent one of the side surface 211c is approximately 48°. That is, the LEDs 12 are disposed such that, as shown in FIG. 14, an angle θ202 that is formed by an optical axis L1 of one of the LEDs 12 and a side surface F211a, which is a substitute of the side surface 211a in a case in which the side surface 211a is assumed not to be formed in the depressed shape, is approximately 42°.

Thus, part of light that is emitted from the LEDs 12 to enter the light guide plate 211 travels parallel to the B-direction, and thus, in a case in which it is assumed that the side surface 211a is not formed in a depressed shape, a light emitting region R201 that emits light by being irradiated with light from one of the LEDs 12 (the one at the top left in FIG. 14) is as shown as a hatching region in FIG. 14.

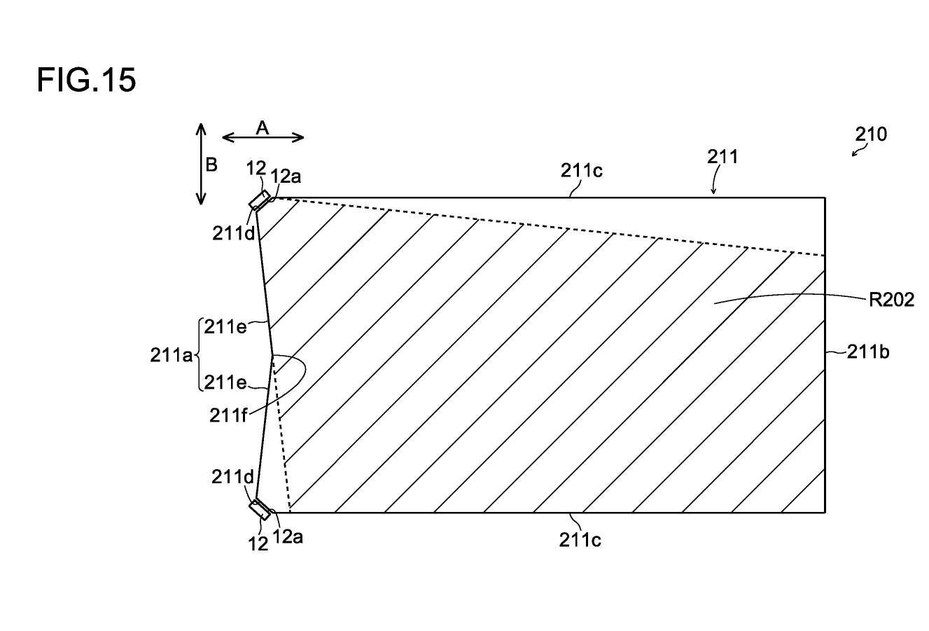

In the third embodiment, since the side surface 211a is formed in the depressed shape, a light emitting region R202 that emits light by being irradiated with light from one of the LEDs 12 (the one at the top left in FIG. 15) is as shown as a hatching region in FIG. 15.

The side surface 211a (the flat surface portions 211e) has a function of reflecting light that travels toward the side surface 211a after entering the light guide plate 211 to the effective light emitting region S201 side.

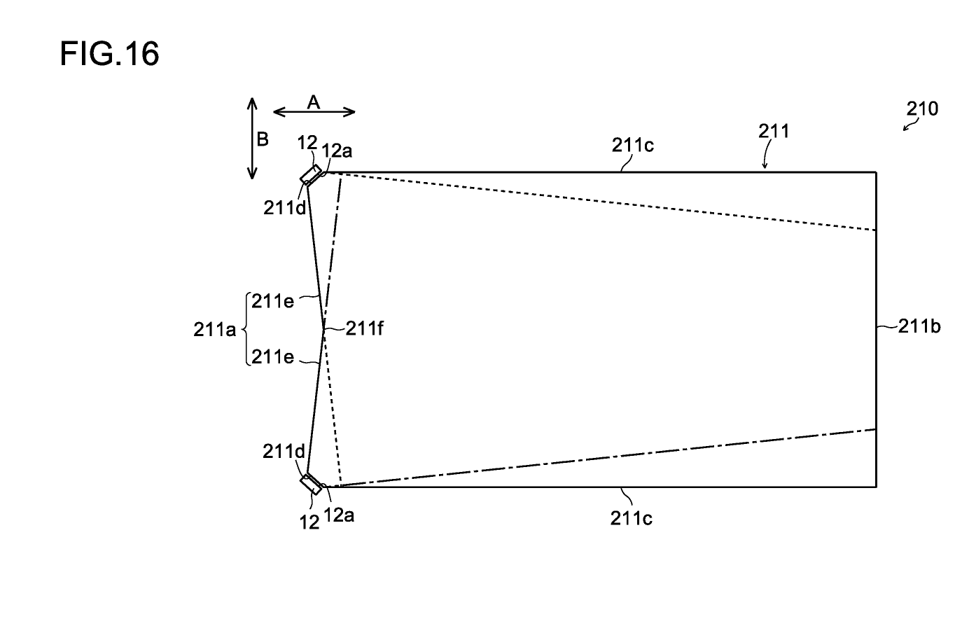

Furthermore, in the third embodiment, since the LEDs 12 are disposed at two corners of the light guide plate 211 as shown in FIG. 16, the entire light guide plate 211 is a light emitting region. Incidentally, in FIG. 16, boundary surfaces of regions that emit light by being irradiated with light from the LEDs 12 are indicated by lines of as many different types to help distinguish which of the light emitting regions corresponds to which of the LEDs 12.

In the other respects, the configuration of the third embodiment is similar to those of the above-described first and second embodiments.

In the third embodiment, as described above, the LEDs 12 are disposed at two adjacent corners of the light guide plate 211, and only the side surface 211a is formed in a depressed shape. With this configuration, in a case in which the LEDs 12 are disposed at two adjacent corners of the light guide member, it is possible to both maximize the effective light emitting region S201 and make the light guide plate 211 compact and lightweight. In addition, since the number of LEDs 12 can be reduced in comparison with the case in which the LEDs 12 are disposed at the four corners of the light guide member, it is possible to make the backlight device 210 still more compact and lightweight.

Moreover, in the third embodiment, the side surface 211a is formed to reflect light that travels thereto after entering the light guide plate 211 to the effective light emitting region S201 side. This makes it possible to reduce loss of light that enters the light guide plate 211. That is, it is possible to reduce degradation of light use efficiency.

The other advantages of the third embodiment are similar to those of the above-described first and second embodiments.

### Fourth Embodiment

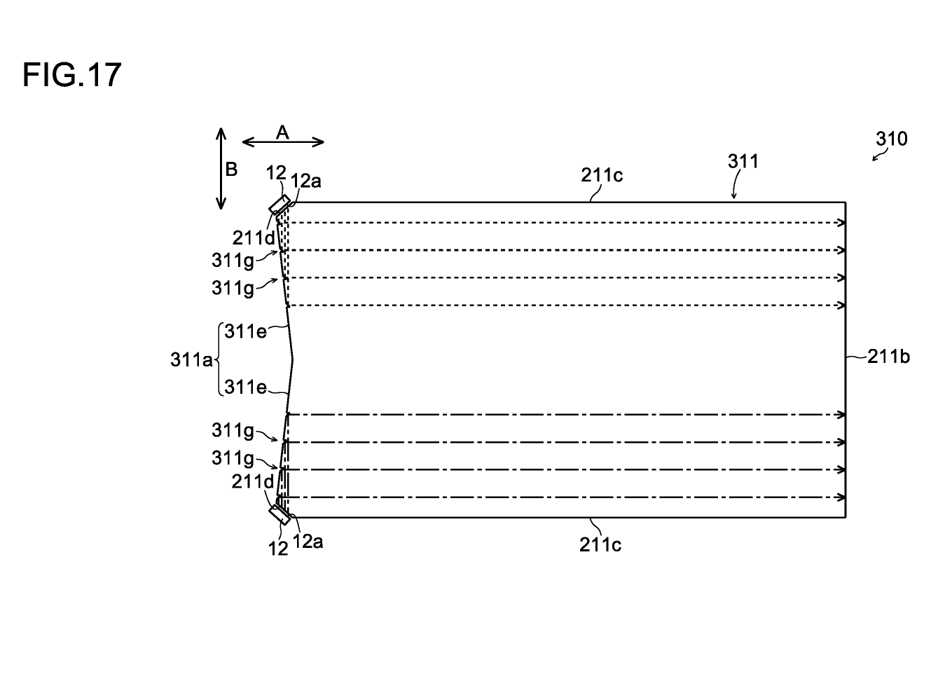

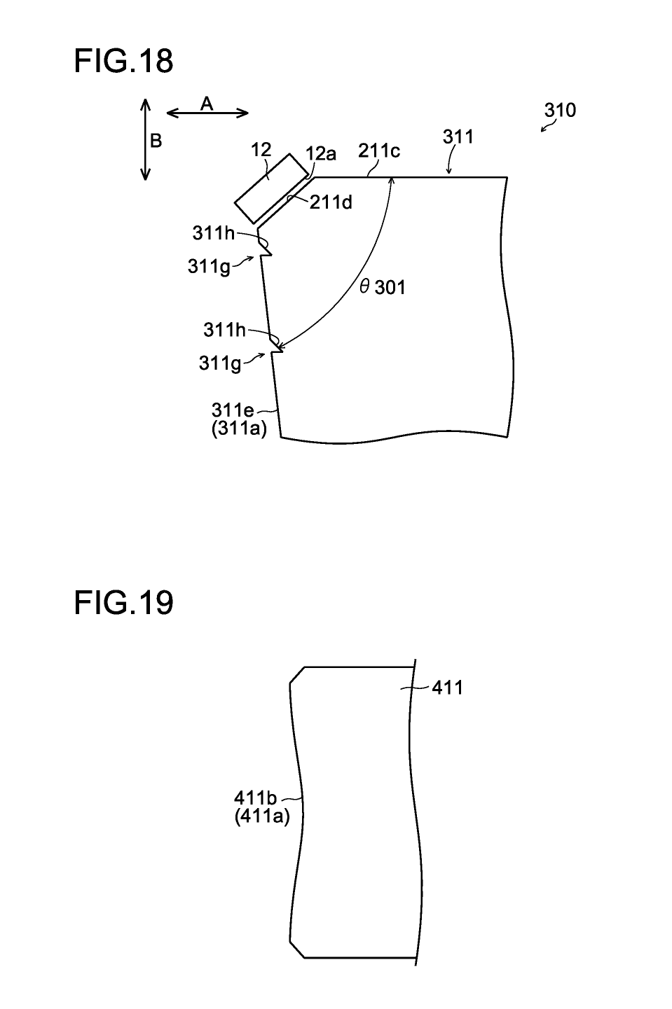

In a fourth embodiment, with reference to FIGS. 17 and 18, a description will be given of a case in which, in contrast to the third embodiment, a prism 311g is formed on a side surface 311a of a light guide plate 311.

As shown in FIG. 17, a backlight device 310 according to the fourth embodiment of the present invention is provided with the light guide plate 311, which is formed in a substantially rectangular shape, and two LEDs 12 which are disposed at two corners of the light guide plate 311 to face the corners. The light guide plate 311 is an example of the “light guide member” of the present invention.

The light guide plate 311 includes a pair of side surfaces 311a and 211b that are located to face each other in an A-direction (a long-side direction), a pair of side surfaces 211c that are located to face each other in a B-direction (a short-side direction) which is perpendicular to the A-direction, and light incident surfaces 211d formed in two adjacent corners of the light guide plate 311. The side surface 311a is an example of the “side surface located between adjacent ones of the light incident surfaces” and the “first side surface.”

Furthermore, the side surface 311a is formed of a plurality of (two) flat surface portions 311e.

Here, in the fourth embodiment, a plurality of prisms 311g are formed on the flat surface portions 311e (the side surface 311a). The prisms 311g include a reflection surface 311h (see FIG. 18) which reflects light traveling toward the side surface 311a to an inside of the light guide plate 311 (the side surface 211b side). The reflection surface 311h is formed, as shown in FIG. 18, such that an angle θ301 formed by the reflection surface 311h and the side surface 211c is approximately 45°.

The prisms 311g can be formed simultaneously when the light guide plate 311 is formed by injection molding. Incidentally, the prisms 311g may be formed by cutting.

In the other respects, the configuration of the fourth embodiment is similar to that of the above-described third embodiment.

In the fourth embodiment, the prisms 311g are made, as described above, on the side surface 311a (the flat surface portions 311e). With this configuration, it is possible to reflect light travelling toward the side surface 311a to an inside of the light guide plate 311 (the side surface 211b side), and this makes it possible to achieve uniform emission of light from the light guide plate 311 and to achieve more uniform brightness of a liquid crystal display panel as well.

The other advantages of the fourth embodiment are similar to those of the first to third embodiments.

The embodiments disclosed herein are to be considered in all respects as illustrative and not restrictive. The scope of the present invention is set out in the appended claims and not in the description of the embodiments hereinabove, and includes any variations and modifications within the sense and scope equivalent to those of the claims.

For example, the above-described embodiments have dealt with cases where a display panel and a display device are applied to a liquid crystal display panel and a liquid crystal display device, respectively, but this is not meant to limit the present invention, and the display panel and the display device may be applied to those of any other type.

Furthermore, in the above-described embodiments deal with examples where liquid crystal display devices are used in portable devices such as mobile phones, but this is not meant to limit the present invention, and liquid crystal display devices may be used in portable devices other than mobile phones, and electronic devices other than portable devices. Note that, however, portable devices are particularly required to be compact, lightweight, and power saving (improved light use efficiency), and thus, it is particularly effective to use the liquid crystal display device of the present invention in portable devices.

Moreover, although the above-described embodiments deal with examples where LEDs are used as point light sources, this is not meant to limit the present invention, and point light sources other than LEDs may be used.

Besides, although the above-described embodiments deal with examples where a side surface that is formed in a depressed shape is formed of two flat surface portions, but this is not meant to limit the present invention, and a side surface that is formed in a depressed shape may be formed of three or more flat surface portions. In addition, like, for example, a light guide plate 411 of a backlight device according to a first modified example of the present invention shown in FIG. 19, a side surface 411a which is formed in a depressed shape, may be formed of one or more curved surface portions 411b.

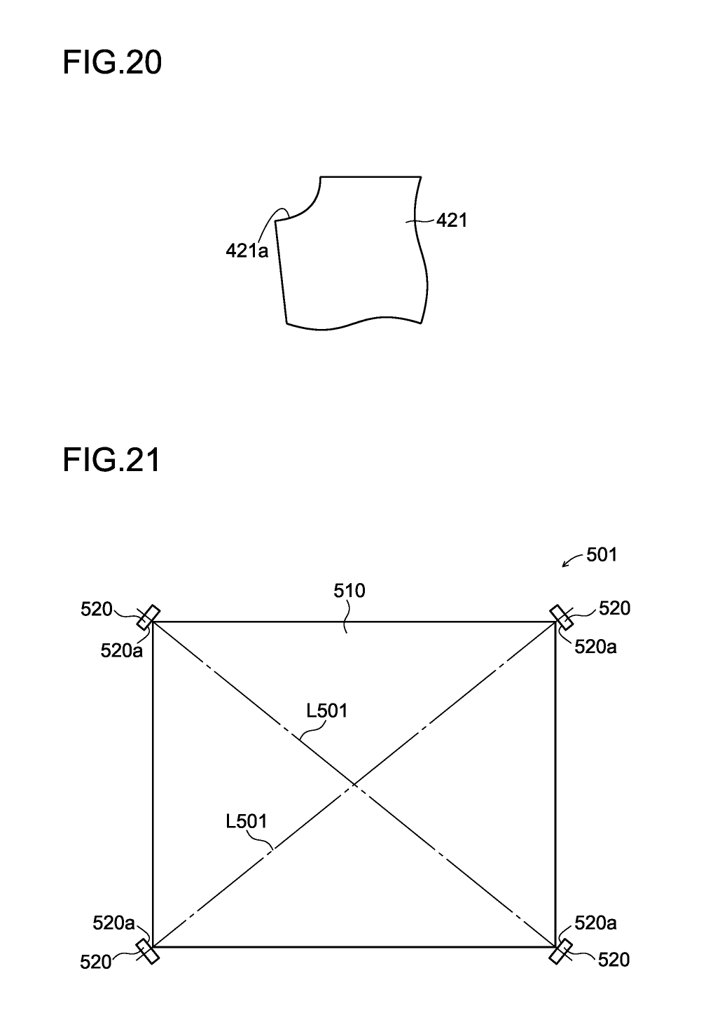

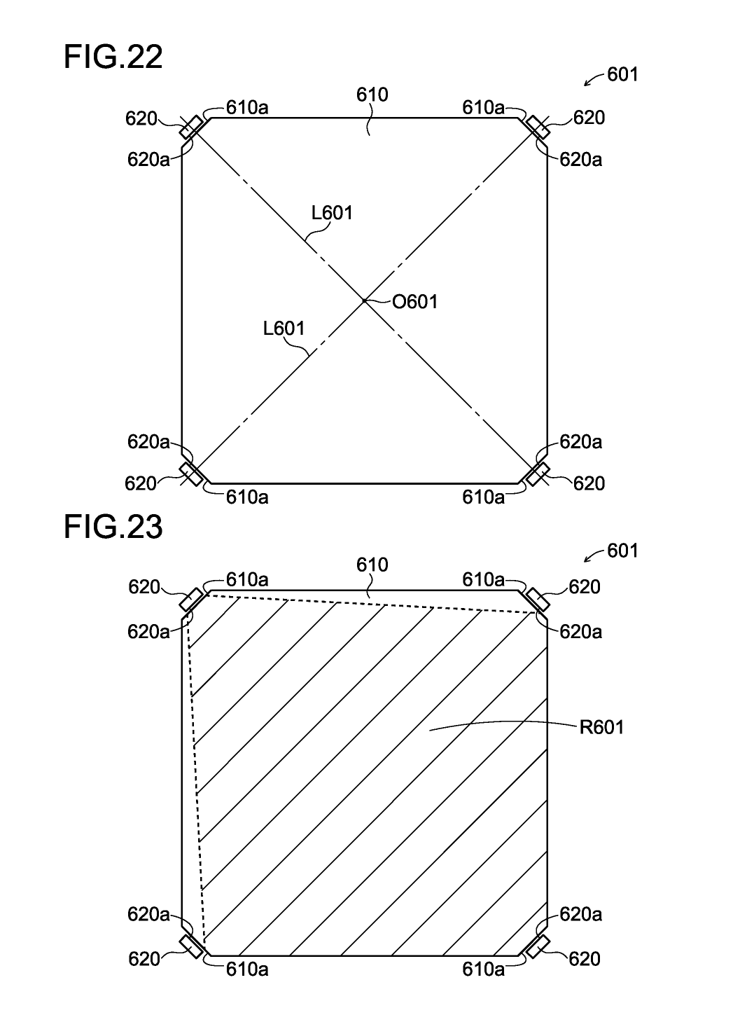

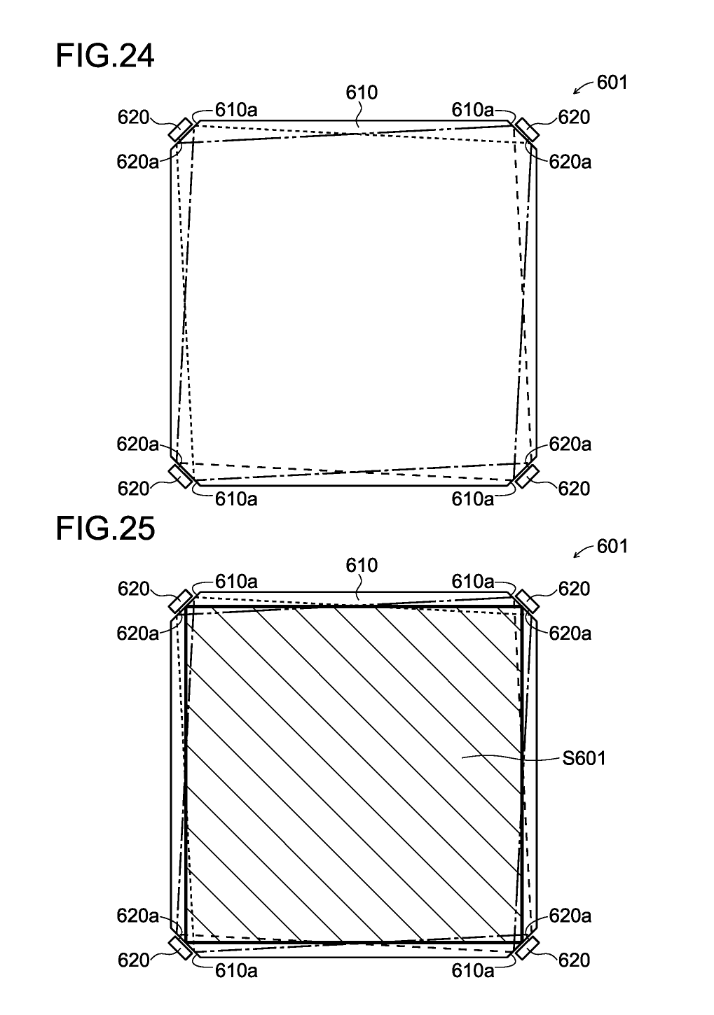

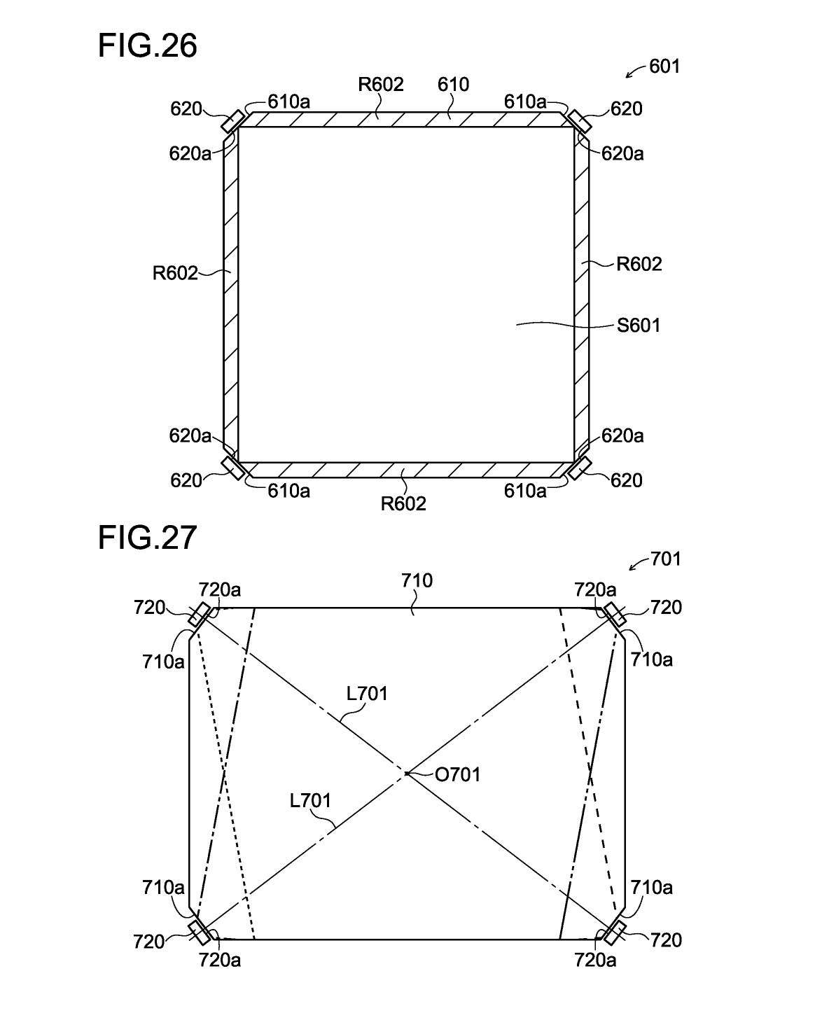

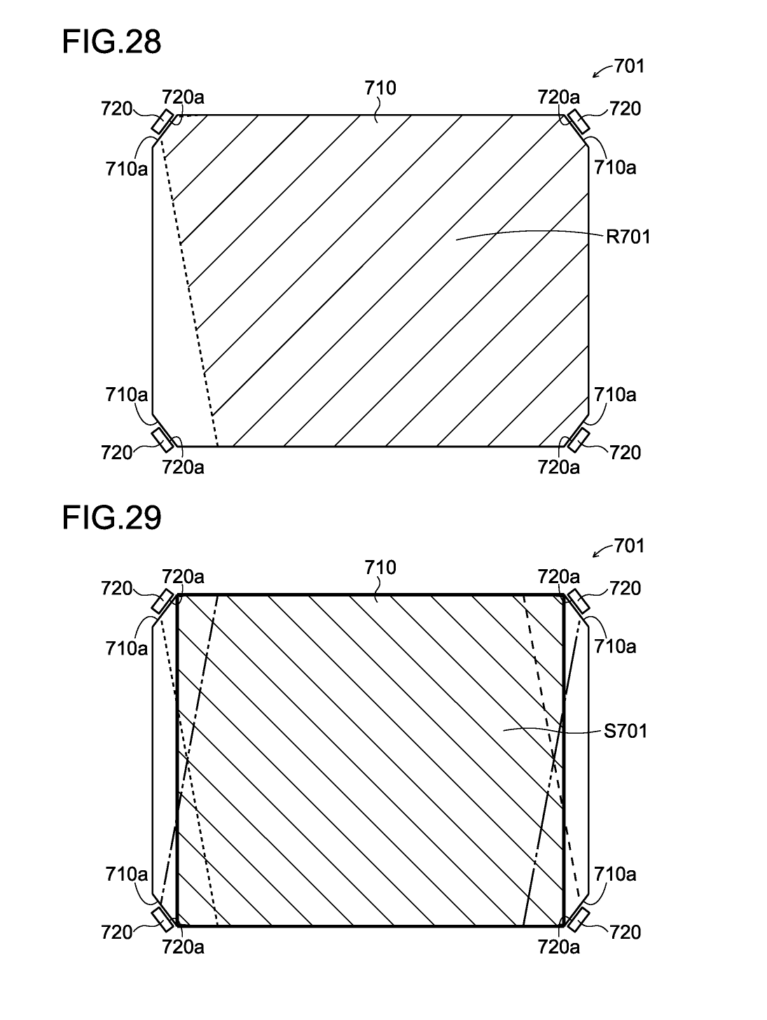

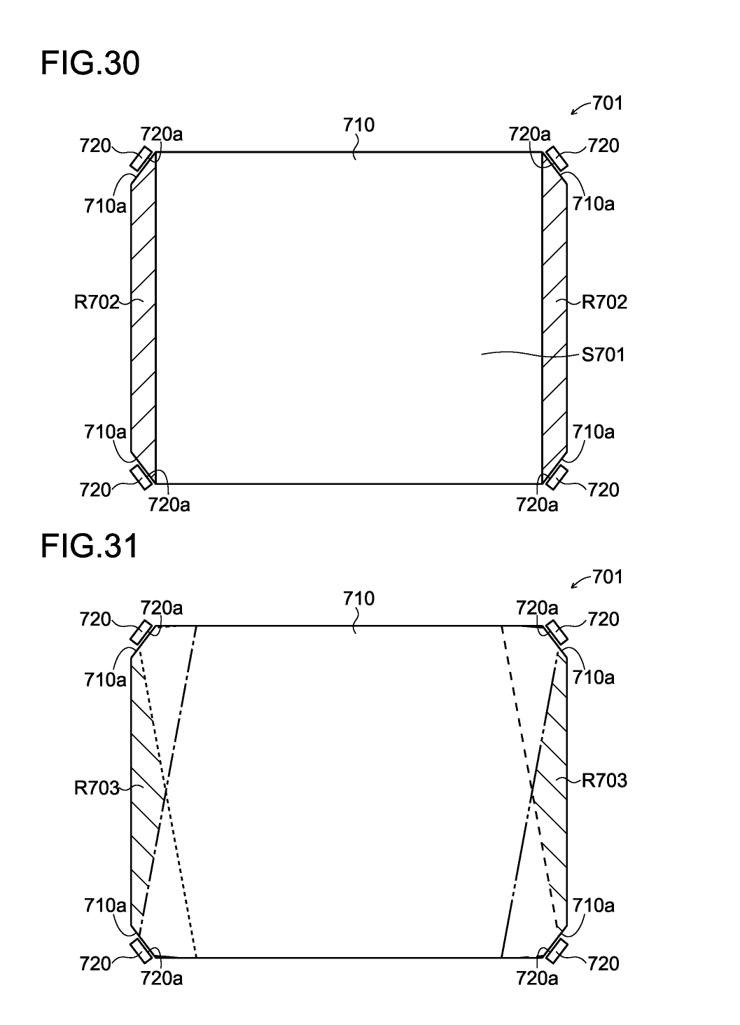

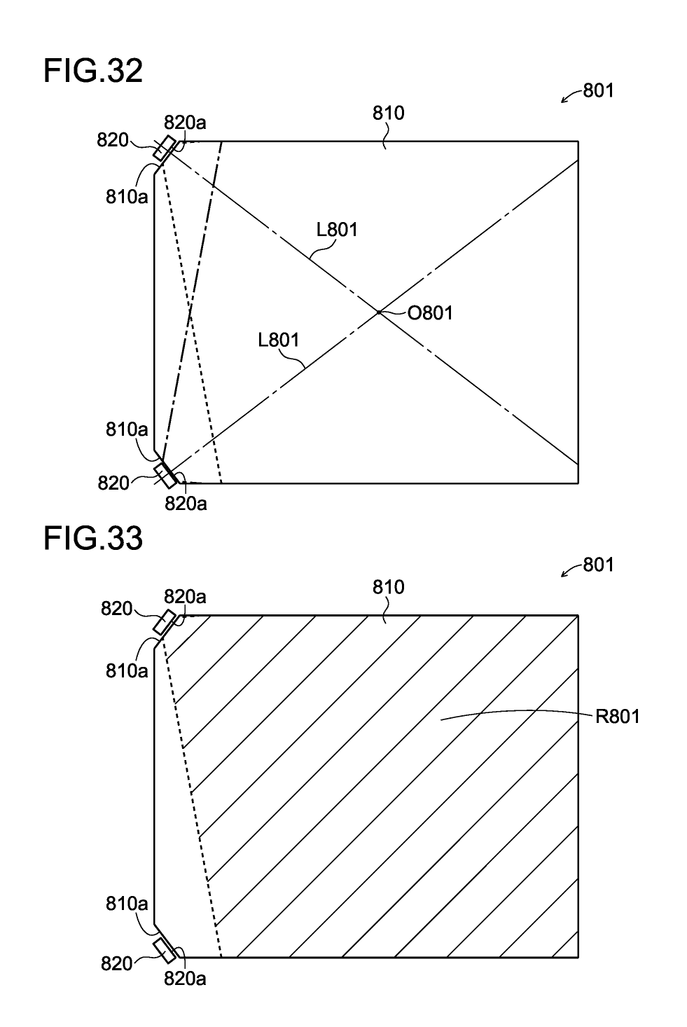

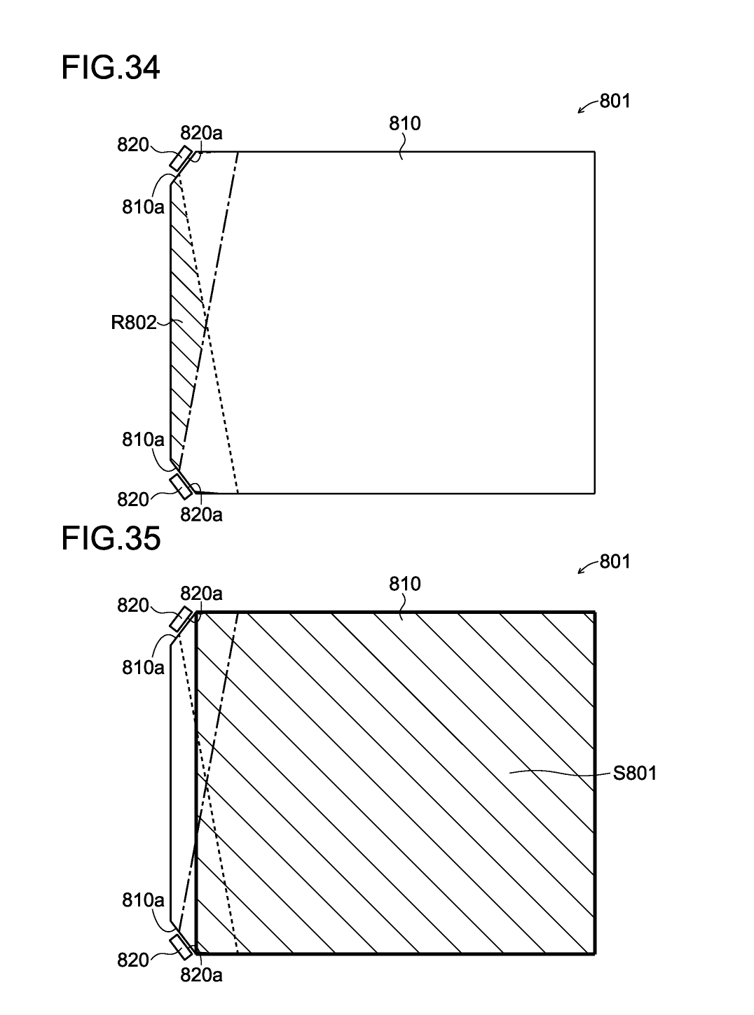

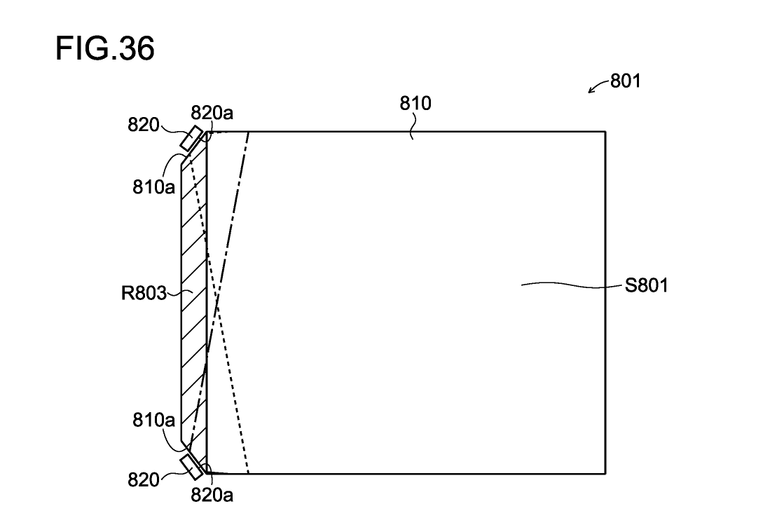

Furthermore, although the above-described embodiments deal with examples where a light incident surface is formed in a flat surface shape, but this is not meant to limit the present invention, and a light incident surface may be formed of a plurality of flat surface portions. Moreover, like, for example, a light guide plate 421 of a backlight device according to a second modified example of the present invention shown in FIG. 20, a light incident surface 421a may be formed in a curved surface shape.

Besides, although the above-described embodiments deal with examples where a light guide plate is formed of a acrylic resin, this is not meant to limit the present invention, and a light guide plate may be formed of, for example, a resin other than acrylic resins, such as a polycarbonate resin having a refraction index of approximately 1.59. A light guide plate may be formed of a material other than resins. In the case where a light guide plate is formed of a material other than acrylic resins, an angle formed by a side surface and an optical axis of an LED may be set to an angle that is suitable to the refraction index of the material.

### LIST OF REFERENCE SYMBOLS

1 liquid crystal display device (display device)

2 liquid crystal display panel (display panel)

10, 110, 210, 310 backlight device

11, 111, 211, 311, 411, 421 light guide plate (light guide member)

11a side surface (side surface located between adjacent light incident surfaces, first side surface, second side surface)

11b, 111c, 211d, 421a light incident surface

11c, 111d, 211e, 311e flat surface portion

12 LED (point light source)

111a, 211a, 311a, 411a side surface (side surface located between adjacent light incident surfaces, first side surface)

111b, 211c side surface (second side surface)

211b side surface (first side surface)

311g prism

411b curved surface portion

L1 optical axis

O101, O201 center

S101, S201 effective light emitting region

θ2, θ103 angle

1. A backlight device, comprising:
a light guide member; and
a plurality of point light sources which irradiate the light guide member with light,
wherein
the light guide member includes a plurality of light incident surfaces, the light incident surfaces being formed in at least two adjacent corners of the light guide member such that the point light sources are disposed to face the light incident surfaces, and a plurality of side surfaces; and
at least one of the side surfaces between adjacent ones of the light incident surfaces is formed in a depressed shape.

2. The backlight device of claim 1,
wherein
the plurality of side surfaces include a pair of first side surfaces which face each other and a pair of second side surfaces which are disposed along a direction that crosses the first side surfaces;
a length of the first side surfaces is not longer than a length of the second side surfaces; and
at least one of the pair of first side surfaces is located between the plurality of light incident surfaces and formed in a depressed shape.

3. The backlight device of claim 2,
wherein
the length of the first side surfaces is shorter than the length of the second side surfaces;
the light guide member includes an effective light emitting region corresponding to a display region of a display panel; and
a center of the effective light emitting region of the light guide member is disposed a predetermined distance away from optical axes of the point light sources.

4. The backlight device of claim 2,
wherein
the light incident surfaces are formed in four corners of the light guide member; and
the pair of first side surfaces are both formed in a depressed shape.

5. The backlight device of claim 2,
wherein
the light incident surfaces are formed in two adjacent corners of the light guide member; and
only one of the pair of first side surfaces is formed in a depressed shape.

6. The backlight device of claim 1,
wherein
an angle formed by two of the side surfaces adjacent to the light incident surfaces is substantially as large as a spread angle at which light from the point light sources spreads on entering the light guide member.

7. The backlight device of claim 1,
wherein
the light guide member includes an effective light emitting region corresponding to a display region of a display panel; and
a side surface among the side surfaces that is formed in a depressed shape has a function of reflecting light that enters the light guide member to the effective light emitting region side.

8. The backlight device of claim 7,
wherein
a prism is formed on the side surface among the side surfaces that is formed in the depressed shape.

9. The backlight device of claim 1,
wherein
the light incident surfaces are formed as a flat surface or a curved surface.

10. The backlight device of claim 1,
wherein
a side surface among the side surfaces that is formed in a depressed shape includes a plurality of flat surface portions or at least one curved surface portion.

11. A display device comprising:
the backlight device of claim 1; and
a display panel which is illuminated by the backlight device.
